(19) United States
(12) Patent Application Publication
(10) Pub. No.: US 2003/0105778 A1
(43) Pub. Date: Jun. 5, 2003

(54) File generation apparatus and method

(75) Inventor: Babita H. Andani, Beaverton, OR (US)

Correspondence Address: Schwegman, Lundberg,, Woessner & Kluth, P.A., P.O. Box 2938, Minneapolis, MN, 55402, US

(73) Assignee: Intel Corporation

(21) Appl. No.: 09/999,280

(22) Filed: Nov. 30, 2001

(51) Int. Cl. G06F 12/00

(52) U.S. Cl. 707/200

(57) ABSTRACT

A file generation apparatus, system, and article including a machine-accessible medium, along with a method of generating files, are disclosed. The apparatus may include a Template Generation Module (TGM) coupled to a File Generation Module (FGM). The apparatus is capable of generating templates, which in turn specify additional template data that can be used to automatically generate device and service description files, according to received file format specification and device identification data. The system may include a processor coupled to a local memory which includes a file generation program module and a template generation program module. The method may include receiving a specification and device identification for a device providing at least one service, generating one or more template files related to the specification identification and the device identification, receiving additional template data specified by the template file(s), generating a device description file using the additional template data, and generating at least one service description file.

### FIELD OF THE INVENTION

The present invention relates generally to apparatus and methods used for data processing and file generation. More particularly, the present invention relates to combining user-entered data with templates for the automated generation of descriptive files.

### BACKGROUND INFORMATION

The addition of device Plug and Play (PnP) capabilities to operating systems makes it very easy to set up, configure, and add peripherals to a personal computer (PC). The concept of Universal Plug and Play (UPnP) extends this simplicity to include enabling discovery and control of various devices within a network. However, UPnP is more than just a simple extension of the Plug and Play peripheral model. UPnP enables a device to dynamically join a network, obtain an IP address, convey its capabilities, and learn about the presence and capabilities of other devices in an automated fashion.

The basic building blocks of a UPnP network are devices, services and control points. A UPnP device is a container of services and nested devices. For instance, a VCR device may include a tape transport service, a tuner service, and a clock service. A TV/VCR combination device would include not just of services, but a nested television receiver device as well. Different categories of UPnP devices are associated with different sets of services and embedded devices. However, for the most part, the set of services a particular generic device type provides have been standardized. The information is typically captured in an eXtensible Markup Language (XML) device description document, which lists the properties (such as the device name and icons) associated with the device, in addition to the set of services provided.

The smallest unit of control in a UPnP network is a service. A service exposes actions and models its state with state variables. For instance, a clock service may be modeled as having a state variable, current_time, which defines the state of the clock, and two actions, set_time and get_time, which allow the service to be controlled. In a fashion similar to that of the device description, service information is typically made part of an XML service description. A pointer (e.g., a Universal Resource Locator, or URL) to applicable service descriptions is contained within the device description.

The Universal Plug and Play Forum (the “Forum”) defines UPnP Device and Service Descriptions according to a common device architecture, known as the UPnP Device Architecture, as specified in the “Universal Plug and Play Device Architecture” document, Ver. 1.0. The Forum is an association of more than 200 vendors in the areas of consumer electronics, computing, home automation and security, home appliances, computer networking, and mobile devices. The Forum's web site, http://www.UPnP.org/, is the central repository for schema that have been developed and standardized by the Forum. The Device Architecture document, templates for device and service descriptions, and guidelines for device and service description design are also published at the site.

Thus, while file formats may be ultimately defined by the Forum, device developers are required to individually implement two types of XML files for each device: a Device Description File (DDF), and one or more Service Description Files (SDFs). This typically occurs as part of a manual process, depending on a human operator to have knowledge of the intricacies XML, as well as the required/optional fields and tags. The process of creating description files also relies on the human operator to enter accurate data. As is the case with most other human-dependent endeavors, manual construction of lengthy XML files according to non-intuitive language rules and structured templates, along with embedded data entry, often results in errors which propagate throughout the device development, testing, and production environments. Such errors lead to increased costs throughout the product life cycle, including those incurred via consumer dissatisfaction with “faulty” products (which may simply be handicapped by an erroneous SDF entry).

Therefore, there is a need in the art for an apparatus, an article including a machine-accessible medium, a system, and a method of generating accurate DDFs and SDFs in a more rigorous and dependable manner. Solutions should take into account the need to reduce opportunities for human participation in the process, minimizing the number of data entry errors, and ultimately leading to decreased product life-cycle cost and increased consumer satisfaction.

### BRIEF DESCRIPTION OF THE DRAWINGS

FIG. 1 is an illustration of a prior art audio jukebox device control panel display;

FIG. 2 is a prior art XML DDF for the audio jukebox device shown in FIG. 1;

FIG. 3 is a portion of a prior art XML SDF referenced by the DDF shown in FIG. 2;

FIG. 4 is a block diagram of an apparatus, an article including a machine-accessible medium, and a system according to various embodiments of the present invention; and

FIG. 5 is a method of generating files according to an embodiment of the present invention.

### DESCRIPTION OF THE PREFERRED EMBODIMENTS

In the following detailed description of the invention, reference is made to the accompanying drawings which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to practice the invention. Other embodiments may be utilized and derived therefrom, such that structural and logical substitutions and changes may be made without departing from the scope of the invention. The following detailed description, therefore, is not to be taken in a limiting sense, and the scope of the invention is defined only by the appended claims, along with the full range of equivalents to which such claims are entitled.

UPnP vendors and manufacturers, UPnP Forum Working Committees, and the UPnP Device Architecture document define the highest layer protocols used to implement UPnP. Based on the Device Architecture document, the working committees define information global to generic device types such as VCRs, HVAC systems, dishwashers, and other appliances. Subsequently, UPnP Device vendors and manufacturers define the data specific to their devices such as the model name, URL, etc.

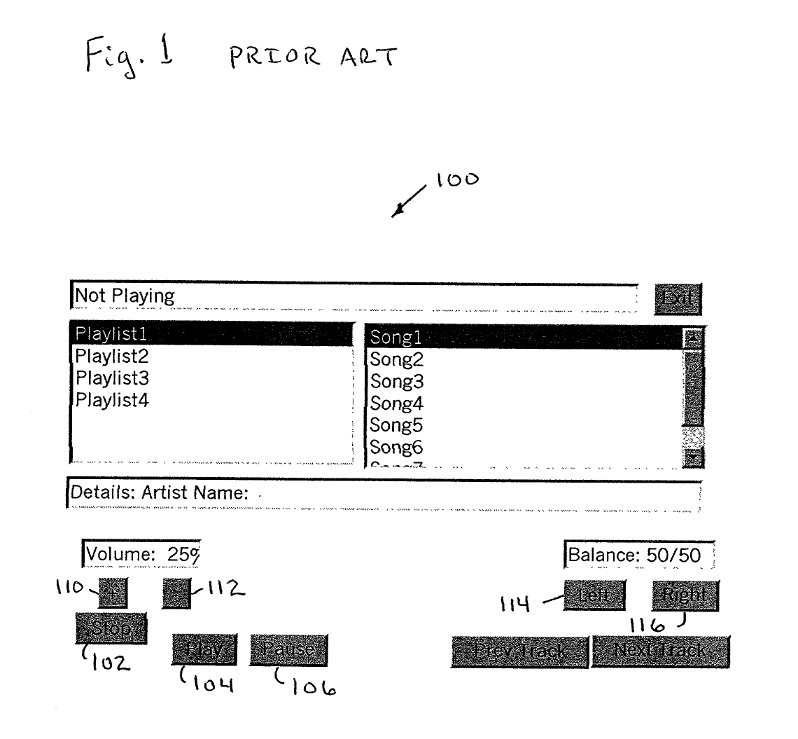

FIG. 1 is an exemplary computer screen control panel display for a prior art UPnP device: an audio jukebox. The control panel 100 includes buttons which can be used to control or manipulate several of the actions (i.e., part of the services) offered by the device. In this case, the buttons may correspond to transport service actions (e.g., Stop 102, Play 104, Pause 106), connector service actions (e.g. source connect, source disconnect), and audio service actions (e.g., volume up 110, volume down 112, balance left 114, balance right 116).

Once a device is attached to a network and addressed appropriately, the first step in the UPnP networking process, discovery, can take place. The Simple Service Discovery Protocol (SSDP) is used as the mechanism by which a device newly added to a network advertises its services to control points (which ultimately control individual devices) on the network. When a control point is added to the network, the SSDP allows that control point to search for devices of interest. The fundamental exchange in both cases is a discovery message containing essential information about the device or one of its services, for example the device type, its identifier, and a pointer to its XML DDF.

The next step in UPnP networking is description. After a control point has discovered a device, the control point still knows very little about the device. For the control point to learn more about the device and its capabilities, or to interact with the device, the control point must retrieve the device's DDF from the URL provided by the device in the discovery message.

The UPnP DDF for a device includes vendor-specific information including the model name and number, serial number, manufacturer name, URLs to vendor-specific Web sites, and so forth. The description also includes a list of any embedded devices or services, as well as URLs for the UPnP processes of control, eventing, and presentation.

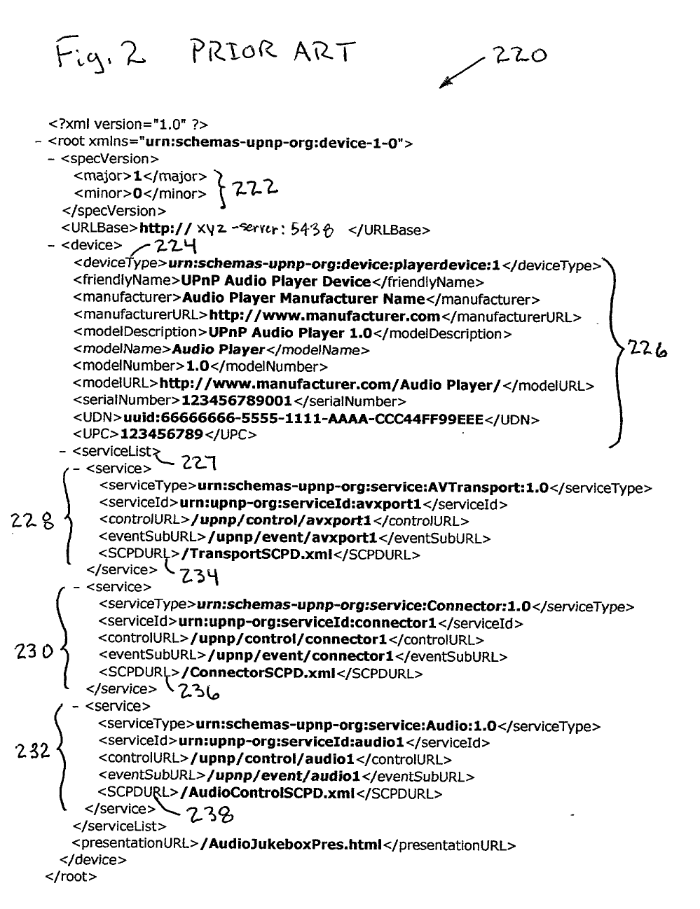

For example, FIG. 2 is a prior art XML DDF for the audio jukebox device shown in FIG. 1. In this DDF 220, the version 222 of the UPnP specification is designated as 1.0. The device type 224 is designated as “playerdevice”, which is generic for an audio player device. Manufacturer specific information 226, such as the name of the manufacturer, the make and model of the device, as well as various pointers (URLs) are also included.

After the manufacturer's information, a list of services 227 is referenced. In this case, as noted above, the services correspond to transport 228, connection 230, and audio 232 functions. Each XML SDF is specifically called out. Thus, the transport SDF is contained in “TransportSCPD.xml” 234, the connector SDF is contained in “ConnectorSCPD.xml” 236, and the audio SDF is contained in “AudioControlSCPD.xml” 238.

After a control point has retrieved a description of the device, the control point has the essentials for device control. To learn more about services offered by the device, the control point must retrieve a detailed UPnP description for each service. As noted above, service descriptions are also expressed in the form of XML files. These SDFs include a list of the commands, or actions, to which a particular service responds, as well as parameters or arguments for each action. Each SDF also includes a list of variables; these variables model the state of the service at run time, and are described in terms of their data type, range, and event characteristics.

To control a device, a control point sends an action request to one of the services provide by the selected device. To do this, a control point sends a suitable control message to the control URL for the service (provided in the DDF). In response to the control message, the service returns action specific values or fault codes. Other typical UPnP activities include eventing and presentation, which will not be discussed further herein. For more information, please see the Forum web site: http://www.UPnP.org/.

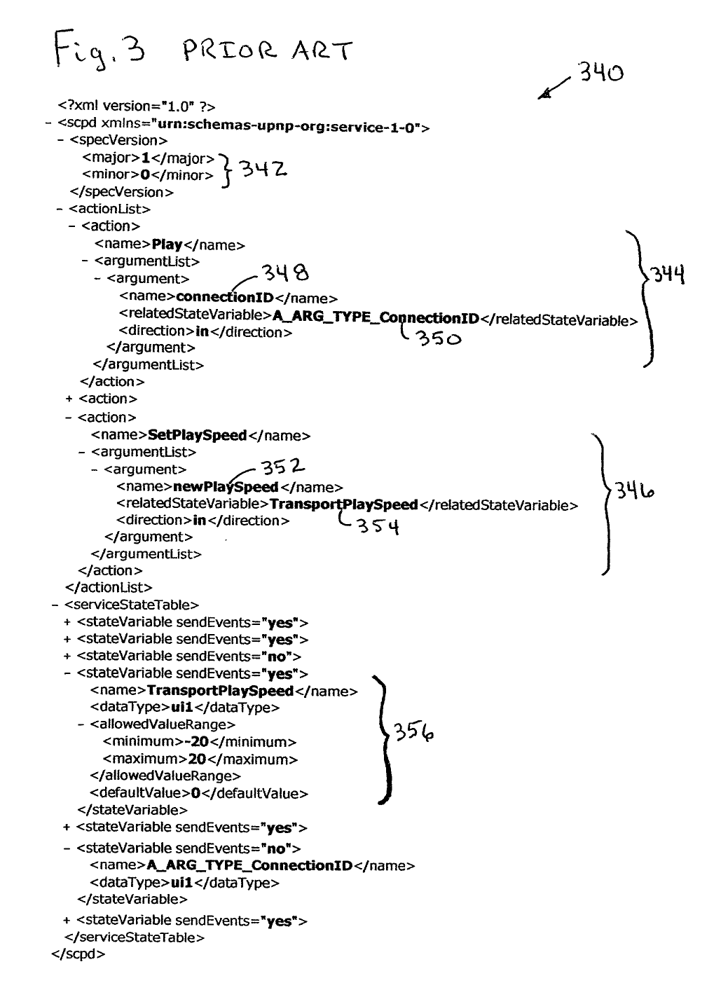

An example of a portion of a prior art XML SDF referenced by the juke box DDF is shown in FIG. 3. In this case, major portions of the transport service SDF have been excerpted. As is the case with the DDF in FIG. 2, the version 342 of the UPnP specification is called out as “1.0”. One or more actions available under the transport service are also specified. In this case, the “Play” 344 and “SetPlaySpeed” 346 actions have been designated. Each action may have one or more arguments, along with related state variables. Examples include the “connectionID” argument 348 and the variable “A_ARG_TYPE_ConnectionID” 350, as well as the “newPlaySpeed” argument 352, with its related state variable “TransportPlaySpeed” 354. After all of the actions are defined in terms of their arguments and state variables, the state variables themselves are defined. Thus, for example, the state variable “TransportPlaySpeed” 356 may be defined in terms of its data type, allowed range, and default value.

The invention provides a semi-automated environment for the creation of hardware description files, such as DDFs and their corresponding SDFs. In particular, the apparatus, system, article, and method of the invention provide an efficient mechanism for generating files related to devices providing one or more services according to preselected formats. Use of the invention in its various embodiments provides an opportunity to reduce human error with regard to data entry and program file construction, with the inherent advantage of decreasing device development cost, and increasing consumer satisfaction.

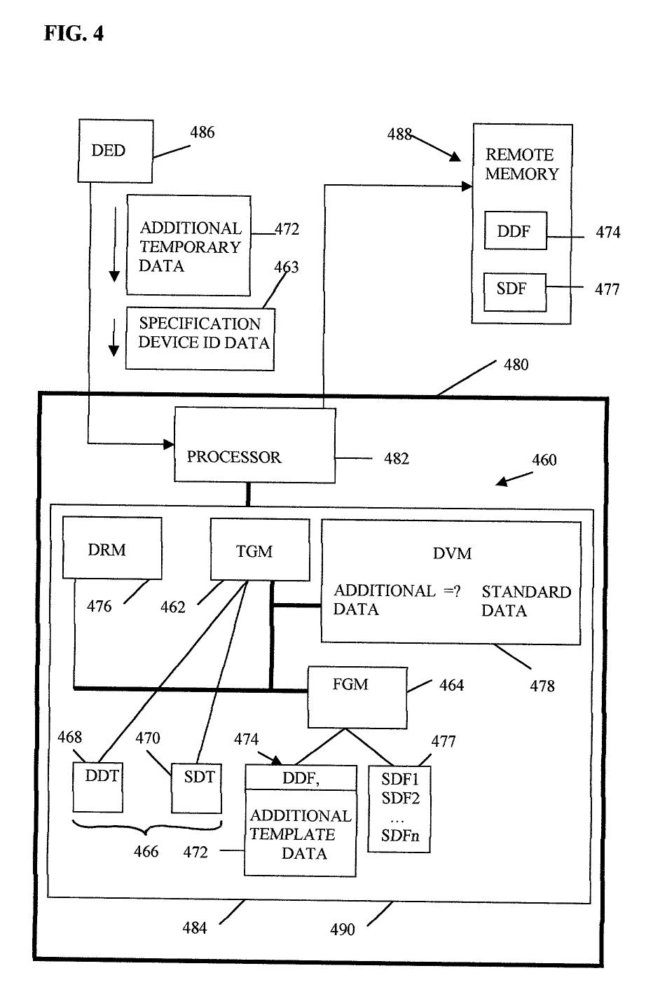

FIG. 4 is a block diagram of an apparatus, an article including a machine-accessible medium, and a system according to various embodiments of the present invention. In one embodiment of the invention, a file generation apparatus 460 may include a Template Generation Module (TGM) 462 and a File Generation Module (FGM) 464 capable of being communicatively coupled together. The TGM 462 is capable of receiving identification data 463, such as a file format specification identification, which may take the form of a specification name and version (e.g., the Microsoft™ “Universal Plug and Play Device Architecture” document, Ver. 1.0), or possibly just the version of a particular file specification format (e.g., 1.0) if the TGM 462 is dedicated to operating under a particular named specification file format. The TGM 462 is also capable of receiving identification data 463, such as a device identification for which related template files (or “templates”) will be generated. For example, the device identification may be that of a generic device, such as a Compact Disc (CD) player (e.g. the UPnP device CDPlayer:1, which is a CD player that can hold one or more CDs internally, play a CD, control volume, tone, spatial balance, and provide an output signal via external, analog connectors).

A list, or at least the number, of services provided by the device will also typically be received by the TGM 462 as part of the identification data 463. In the case of a generic CD player device, enabled functions (actions under the services) might include adding and removing discs; manually playing, pausing, and stopping play; automatically playing a disc when inserted; playing tracks and discs in order; and playing tracks and discs randomly.

After receiving the identification data 463, the TGM 462 may then automatically generate one or more template files 466, such as a Device Description Template (DDT) file 468, related to the device identification. One or more Service Description Template (SDT) files 470 may also be automatically generated, each related to one or more of the provided service(s). Typically, the TGM 462 will generate the various template files 466 according to the requirements of a commercial standard. For example, in the case of the CDPlayer:1 UPnP device, the standard might be the UPnP Device Architecture specification described above.

At this point, the FGM 464 typically receives additional template data 472 which is specific to the developer or manufacturer of the identified device, as well as the device itself. For example, referring back to FIG. 2, the developer will typically enter data into various fields corresponding to data in the template files 466, such as the manufacturer specific information 226 in the DDF of FIG. 2, or manufacturer-specific actions which may be defined in an SDF for services offered by the device (e.g., see actions 344, 346 shown in FIG. 3).

The FGM 464 is capable of automatically generating a Device Description File (DDF) 474 containing the additional template data 472 associated with the device, as specified by the template 468 and formatted in accordance with the file format specification identification. Again, for example, in the case of a UPnP device, the standard might be the UPnP Device Architecture specification, which directs the use of XML files. The additional template data 472, along with the identification data 463, may be received by way of a Data Reception Module 476 capable of being communicatively coupled to the FGM 464.

The file generation apparatus 460 is also capable of automatically generating one or more Service Description Files (SDFs) 477 associated with the provided service(s) and the generated SDTs 470. As is the case for the DDF 474, each SDT 470 will typically be formatted in accordance with the file format specification identification 463, such as the XML files described in the UPnP Device Architecture specification.

The file generation apparatus 460 may include a template Data Validation Module (DVM) 478 capable of being communicatively coupled to the FGM 464. The function of the DVM 478 is to compare the additional template data 472 with standard template data 480, and to prevent generation of the DDF 474 if the additional template data 472 that has been received is not in accordance with preselected data types, values, and/or limits. Such type, values, and limits may be imposed by a commercial standard, by the device developer, or by any of the modules contained within the apparatus 460. Typically, receipt of improper additional template data 472 is accompanied by publication of an alert message from the DVM 478 to a human operator so that alternative template data may be entered, received, and processed by the DVM 478, enabling generation of the DDF 474.

In another embodiment, it can be seen that a file generation system 480 according to the present invention may include a processor 482 coupled to a local memory 484. The memory 484 may include a FGM 464 and a TGM 462, operating as described above, and therefore capable of generating UPnP DDF 474 and SDF 477 files, or similar files, containing additional template data 472 (as specified by the template files 466 generated by the TGM 462).

The file generation system 480 may also include a Data Entry Device (DED) 486 capable of being communicatively coupled to the processor 482. The DED 486 may generate the additional template data 472 as provided by a manufacturer or developer of the identified device. The DED 486 may be a keyboard, a microphone, a touch screen, a data repository, a memory, a combination of these, or any other device capable of providing the additional template data 472 required by the FGM 464 for rendering the DDF 474 and SDFs 477. The system 480 may also include a remote memory 488, such as a disk drive, floppy disk, or some other storage mechanism capable of being communicatively coupled to the processor 482. The remote memory 488 may be used to store the templates 466 and/or files 474, 477 described previously, such as UPnP DDF and SDF files.

It should be noted that the TGM 462, FGM 464, DRM 476, DVM 478, DED 486, and memories 484, 488 may all be characterized as “modules” herein. Such modules may include hardware circuitry, such as a microprocessor and/or memory circuits, software program modules, and/or firmware, and combinations thereof, as directed by the architect of the apparatus 460 and system 480, and appropriate for particular implementations of the invention.

One of ordinary skill in the art will understand that the file generation apparatus and system of the present invention can be used in applications other than desktop computers and systems which include networked servers or devices, and thus, the invention is not to be so limited. The illustrations of a file generation apparatus 460 and a file generation system 480 are intended to provide a general understanding of the structure of the present invention, and are not intended to serve as a complete description of all the elements and features of file generation apparatus and systems which might make use of the structures described herein.

Applications which may include the novel file generation apparatus and system of the present invention include electronic circuitry used in high-speed computers, communications and signal processing circuitry, processor modules, embedded processors, and application-specific modules, including multilayer, multi-chip modules. Such file generation apparatus and systems may further be included as sub-components within a variety of electronic systems, such as televisions, cellular telephones, personal computers, radios, vehicles, and others.

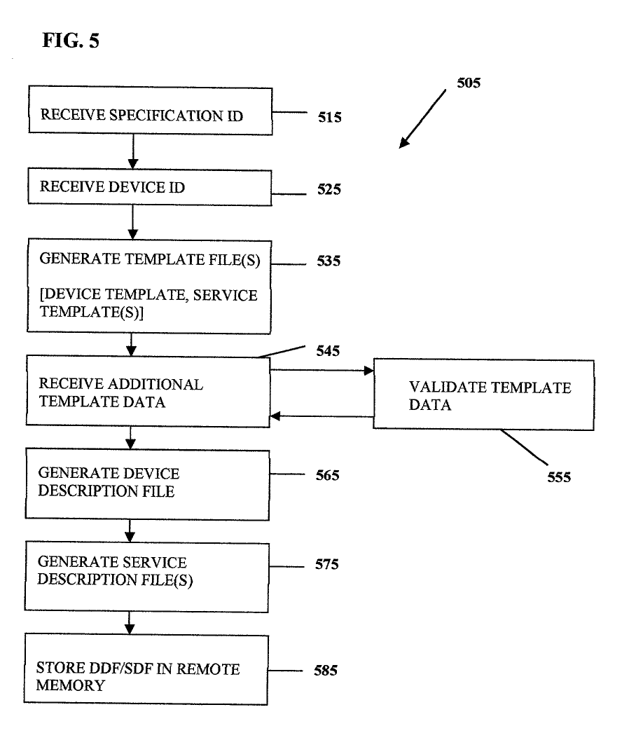

FIG. 5 is a flow diagram illustrating a method of generating files according to an embodiment of the present invention The method 505 may include receiving a specification identification at block 515, and receiving a device identification for a device providing one or more services, such as a UPnP device, at block 525. The method 505 may continue with generating one or more template files related to the specification identification and the device identification, such as a UPnP DDT and one or more UPnP SDTs, each corresponding to the services provided by the identified UPnP device, at block 535.

At this point, additional template data specified by the template file(s) may be received at block 545, as provided by the device developer or manufacturer. The additional template data may be entered using a DED similar to, or identical to that described above, and may be validated at block 555 by comparing the additional template data with standard template data, including the data types, values, and/or limits included in the generated template files, and/or in various standards, such as the UPnP Device Architecture document. As needed, the additional template data may continue to be received at block 545, and validated at block 555. An example of additional template data limits, default values, and data types may be found in the definition of the state variable “TransportPlaySpeed” 356 shown in FIG. 3.

The method 505 may then continue with generating a DDF at block 565, and one or more SDFs at block 575, using the additional template data. As discussed previously, the number of SDFs generated will typically correspond to the number of SDT files, which in turn typically correspond to the number of services provided by the identified device. The method may conclude with storing the template files (e.g., DDT and SDT files) and/or the description files (e.g., DDF and SDFs) in a remote memory, such as a server, a disk drive, or some other storage device, at block 585.

It should be noted that while UPnP templates, files, and standards set forth by the UPnP Forum have been used as examples herein, other templates, files and standards may also be used according to the apparatus, systems, and methods of the invention, and therefore, the invention is not to be so limited. Therefore, it should be clear that the present invention may also be described in the context of computer-executable instructions, such as program modules, being executed by a computer. Generally, program modules may include routines, programs, objects, components, data structures, etc. that perform particular tasks or implement particular abstract data types. As such, the memory 484 of the present invention may include software operative on a processor 482 to perform methods according to the teachings of the present invention.

One of ordinary skill in the art will understand, upon reading and comprehending this disclosure, the manner in which a software program can be launched from a computer readable medium in a computer based system to execute the functions defined in the software program. One of ordinary skill in the art will further understand the various programming languages which may be employed to create a software program designed to implement and perform the methods of the present invention. The programs can be structured in an object-orientated format using an object-oriented language such as Java, Smalltalk, or C++. Alternatively, the programs can be structured in a procedural-orientated format using a procedural language, such as COBOL or C. The software components may communicate using any of a number of mechanisms that are well-known to those skilled in the art, such as application program interfaces (API) or interprocess communication techniques such as the Remote Procedure Call (RPC), Common Object Request Broker Architecture (CORBA), Component Object Model (COM), Distributed Component Object Model (DCOM), Distributed System Object Model (DSOM) and Remote Method Invocation (RMI). However, as will be appreciated by one of ordinary skill in the art upon reading this disclosure, the teachings of the present invention are not limited to any particular programming language or environment, including XML.

As is evident from the preceding description, the processor 482 typically accesses at least some form of computer-readable media, such as the memory 484. However, computer-readable and/or accessible media may be any available media that can be accessed by the apparatus 460. By way of example and not limitation, computer-readable media may compromise computer storage media and communications media. Computer storage media includes volatile and non-volatile, removable and non-removable media implemented in any method or technology for storage of information such as computer-readable instructions, data structures, program modules or other data. Communication media specifically embodies computer-readable instructions, data structures, program modules or other data in a modulated data signal such as a carrier wave, coded information signal, and/or other transport mechanism, which includes any information delivery media. The term “modulated data signal” means a signal that has one or more of its characteristics set or changed in such a manner as to encode information in the signal. By way of example and not limitation, communications media also includes wired media such as a wired network or direct-wired connections, and wireless media such as acoustic, optical, radio frequency, infrared and other wireless media. Combinations of any of the above are also be included within the scope of computer-readable and/or accessible media.

Thus, referring back to FIG. 4, it is now easily understood that another embodiment of the invention may include an article 490 comprising a machine-accessible medium having associated data, wherein the data, when accessed, results in a machine (e.g. a processor or computer) performing activities such as receiving a specification identification and/or a device identification for a device providing at least one service (such as a UPnP device), and generating at least one template file related to the device identification (such as a SDT and/or a DDT). Other activities may include receiving additional template data specified by the template file, and generating a DDF and/or SDFs using the additional template data.

Although specific embodiments have been illustrated and described herein, those of ordinary skill in the art will appreciate that any arrangement which is calculated to achieve the same purpose may be substituted for the specific embodiment shown. This disclosure is intended to cover any and all adaptations or variations of the present invention. It is to be understood that the above description has been made in an illustrative fashion, and not a restrictive one. Combinations of the above embodiments, and other embodiments not specifically described herein will be apparent to those of skill in the art upon reviewing the above description. The scope of the invention includes any other applications in which the above structures and methods are used. The scope of the invention should be determined with reference to the appended claims, along with the full range of equivalents to which such claims are entitled.

What is claimed is:

1. A file generation apparatus, comprising:
a template generation module capable of receiving a file format specification identification and a device identification for a device providing at least one service, and generating a template related to the device identification; and
a file generation module capable of being communicatively coupled to the template generation module and capable of generating a device description file containing additional template data associated with the device as specified by the template and formatted in accordance with the file format specification identification.

2. The file generation apparatus of claim 1, further comprising:
a data reception module capable of being communicatively coupled to the file generation module and receiving the additional template data associated with the device.

3. The file generation apparatus of claim 1, further comprising:
a template data validation module capable of being communicatively coupled to the file generation module and preventing generation of the device description file.

4. The file generation apparatus of claim 3, wherein the template validation module is capable of comparing the additional template data with standard template data.

5. The file generation apparatus of claim 1, wherein the device is a universal plug and play device.

6. The file generation apparatus of claim 1, wherein generating a template related to the device identification includes generating a service description template file related to the at least one service.

7. The file generation apparatus of claim 1, wherein the file generation module is capable of generating a service description file associated with the at least one service and formatted in accordance with the file format specification identification.

8. A file generation system, comprising:
a processor; and
a local memory coupled to the processor, the local memory including a file generation program module and a template generation program module, the file generation program module capable of being communicatively coupled to the template generation module and generating a universal plug and play device description file containing additional template data received in the local memory as specified by a template file generated by the template generation program module.

9. The file generation system of claim 8, further comprising:
a data entry device capable of being communicatively coupled to the processor and generating the additional template data.

10. The file generation system of claim 8, wherein the file generation program module is capable of generating a universal plug and play service description file containing the additional template data received in the memory as specified by a template file generated by the template generation program module.

11. The file generation system of claim 8, further comprising:
a remote memory capable of being communicatively coupled to the processor and storing the universal plug and play device description file.

12. A method of generating files, comprising:
receiving a specification identification;
receiving a device identification for a device providing at least one service;
generating at least one template file related to the specification identification and the device identification;
receiving additional template data specified by the template file;
generating a device description file using the additional template data; and
generating at least one service description file related to the at least one service using the additional template data.

13. The method of claim 12, further comprising:
generating a plurality of service description files related to a corresponding plurality of services provided by the device.

14. The method of claim 12, further comprising:
validating the additional template data.

15. The method of claim 12, wherein generating at least one template file related to the specification identification and the device identification further comprises:
generating a device description template file; and
generating a service description template file.

16. The method of claim 12, wherein the device identification identifies a universal plug and play device.

17. The method of claim 12, further comprising:
storing the device description file and the at least one service description file in a remote memory.

18. An article comprising a machine-accessible medium having associated data, wherein the data, when accessed, results in a machine performing:
receiving a device identification for a device providing at least one service;
generating at least one template file related to the device identification;
receiving additional template data specified by the template file; and
generating a device description file using the additional template data.

19. The article of claim 18, wherein the machine-accessible medium further includes data, which when accessed by the machine, results in the machine performing:
receiving a specification identification.

20. The article of claim 19, wherein the machine-accessible medium further includes data, which when accessed by the machine, results in the machine performing:
generating at least one template file related to the specification identification and the device identification.

21. The article of claim 20, wherein the machine-accessible medium further includes data, which when accessed by the machine, results in the machine performing:
generating at least one service description file related to the at least one service using the additional template data.
